(19) United States
(12) Patent Application Publication
(10) Pub. No.: US 2018/0160827 A1
(43) Pub. Date: Jun. 14, 2018

(54) UPPER-HALF-BODY AUXILIARY BEDSHEET

(71) Applicant: FORWARD CORPORATION, Sakai-shi, Osaka (JP)

(72) Inventor: Tomoko KONO, Uji-shi (JP)

(73) Assignee: FORWARD CORPORATION, Sakai-shi, Osaka (JP)

(21) Appl. No.: 15/571,012

(22) PCT Filed: Apr. 28, 2016
(86) PCT No.: PCT/JP2016/063415

§ 371 Date: Oct. 31, 2017

(30) Foreign Application Priority Data
May 1, 2015 (JP) 2015-093788

(51) Int. Cl. A47G 9/02

(52) U.S. Cl. CPC A47G 9/0238; A61G 7/05

(57) ABSTRACT

An upper-half-body auxiliary bedsheet includes: a rectangular covering section for covering the front surface of an upper portion of a bed; left and right folding-back sections respectively extending from left and right sides of the covering section, each section having a width greater than the thickness of the bed; a head section extending from the head side of the covering section, having a length greater than the thickness of the bed; and left and right connecting members for respectively connecting a left and right end at a boundary between the covering section and the head section, to a predetermined left and right portion at a distal end side of the head section. The bedsheet includes side portions without a bag shape, thereby facilitating the partial putting on and removing of the bedsheet. Both side surfaces of the bed are covered by the folding-back sections, preventing the bed from becoming dirty.

### TECHNICAL FIELD

The present invention relates to an upper-half-body auxiliary bedsheet that covers an area of a bed (e.g. a futon mattress or a mattress) where the upper half of a human body is positioned. The present invention relates, in particular, to an upper-half-body auxiliary bedsheet that is used in hospitals.

### BACKGROUND ART

Beds including futon mattresses and regular mattresses are large in size and considerable in thickness, and thus cannot be easily washed when they have become dirty. In view of this, surfaces of beds are usually covered by bedsheets that are replaceable and can be rather easily washed, in order to prevent the beds from becoming dirty.

Such bedsheets have roughly two types: flat sheets and fitted bedsheets. Among them, fitted bedsheets are more excellent in that they can be more easily put on and removed from beds. A fitted bedsheet is prepared from a single rectangular fabric by folding its top, bottom, left and right sides to the back side, and by sewing the folded portions in adjacent sides to each other, for example. The fitted bedsheet thus prepared has, on the back side, a rectangular opening surrounded by the folded portions. A rubber string passes through the whole or a part of the periphery of the opening. When this fitted bedsheet is to be put on a bed, the opening is widely enlarged by stretching the rubber string, and the bedsheet is overlaid on the bed from this opening to cover the bed.

A typical fitted bedsheet covers the entire front surface of a bed. Another fitted bedsheet has been proposed which covers only a part of the front surface of a bed. In hospitals, a fitted bedsheet that covers only an upper half portion of a bed which easily becomes dirty is often used as an auxiliary bedsheet for a bed used by a patient who cannot move his/her body after an operation, or one who is permanently bedridden.

Patent Literature 1 discloses, for example, an auxiliary bedsheet prepared from a single rectangular fabric by folding its three side portions to the back side, and by sewing the folded portions in adjacent sides to each other to form the sheet into a bag-like shape. This auxiliary bedsheet is attached to an upper half portion of a bed by being put on the head portion of the bed from the side which remains open in the bag-shaped portion. The auxiliary bedsheet put on the bed is removed from the bed by being pulled out from the head side of the bed.

Patent Literature 2 discloses an auxiliary bedsheet formed by folding only one side of a single rectangular fabric to the back side, and by sewing opposite lateral ends of the folded portion to form the folded portion into a bag-like shape. A rubber string extends between opposite lateral ends in the other side (the bottom side) of the auxiliary bedsheet, which is opposite to the bag-shaped side. This auxiliary bedsheet is put on an upper half portion of a bed by inserting the bed from the head portion thereof between the auxiliary bedsheet and the rubber string, and by overlaying the bag-shaped portion on the head portion of the bed. The auxiliary bedsheet put on the bed is removed from the bed by being pulled out from the side of the head portion of the bed either directly or after loosening the rubber string.

### CITATION LIST

### Patent Literature

Patent Literature 1: Japanese Unexamined Patent Application Publication No. 2005-034507

Patent Literature 2: Japanese Unexamined Utility Model Application Publication No. H7-007570

### SUMMARY OF INVENTION

### Technical Problem

According to the auxiliary bedsheet disclosed in Patent Literature 1, the head portion and left-and-right-side edge portions of a bed are inserted in the respective three bag-shaped portions of the bedsheet, so that the bedsheet can be fixedly attached to an upper half portion of the bed. Furthermore, the bedsheet covers not only the front surface of the upper half portion of the bed, but also an area from the front surface to a back-side surface via a top end surface and left-and-right-side surfaces, thereby surely preventing the bed from becoming dirty. However, such a bedsheet requires labor upon being put on and removed from a bed. In particular, such an auxiliary bedsheet is difficult to put on and remove from a bed when a patient is lying on a bed.

The auxiliary bedsheet according to Patent Literature 2 is fixedly attached to a bed with a single bag-shaped portion and a single fixing member. Such a bedsheet can be easily put on and removed from a bed. However, the auxiliary bedsheet is likely to slide due to an active movement of a person on the bed, causing a part of the front surface of the bed to be exposed and become dirty.

An object of the present invention is to provide an upper-half-body auxiliary bedsheet that can be easily put on and removed from a bed, and surely prevents the bed from becoming dirty.

### Solution to Problem

An upper-half-body auxiliary bedsheet according to the present invention developed for solving the previously described problem includes:

a rectangular covering section for covering the front surface of an upper portion of a bed;

left and right folding-back sections respectively extending from the left and right sides of the covering section, each of the left and right folding-back sections having a width greater than the thickness of the bed;

a head section extending from the head side of the covering section, and having a length greater than the thickness of the bed; and

left and right connecting members for respectively connecting the left end and the right end of a boundary area between the covering section and the head section, to a predetermined left position and a predetermined right position at a distal end side of the head section.

Here, the upper portion of the bed indicates an area from the head end (the top end) of the bed to a place where the shoulder of a person lying on the bed is positioned, or to a place where the waist of the person is positioned.

The upper-half-body auxiliary bedsheet according to the present invention may be attached to a bed as follows, for example: First, the head section of the bedsheet is folded in half toward the back side, and then, the left and right predetermined portions at the distal end side of the head section are connected to the left and right end portions of the boundary area between the covering section and the head section, respectively, by the left and right connecting members respectively. It is preferable that the predetermined left and right positions are respectively located on two lines which are extensions of the boundary lines between the covering section and the left folding-back section as well as between the covering section and the right folding-back section. Examples of the connecting members include: a pair of tie strings; hook and loop pieces of a hook-and-loop fastener; a button and a button hole; and others. Each of the connecting members is provided on: a left end portion of the boundary area between the covering section and the head section, and a predetermined position in the left side of the distal end portion of the head section; and a right end portion of the aforementioned boundary area, and a predetermined position in the right side of the distal end portion of the head section. With this, a top portion (head section) of the upper-half-body auxiliary bedsheet is shaped into a bag-like form. When the bag-shaped portion is arranged to cover the head portion of a bed, the top portion of the upper-half-body auxiliary bedsheet is fixed to the bed. The covering section is then spread over the bed by smoothing the wrinkles, and at the end, the left and right folding-back sections are folded back and laid under the bed.

The upper-half-body auxiliary bedsheet according to the present invention may also be attached to a bed in the following steps. First, the covering section and a part of the head section of the upper-half-body auxiliary bedsheet are laid on the front surface of the upper portion of the bed, and then the remaining portion (upper half) of the head section and the left and right folding-back sections are folded back and laid under the bed. Subsequently, the left and right end portions of the boundary area between the covering section and the head section are respectively connected to the predetermined positions at the left and right side of the distal end portion of the head section by the respective left and right connecting members.

Which procedure is adopted for attaching the bedsheet to a bed may be determined depending on the situation, e.g. according to whether or not a person is lying on the bed.

While the upper-half-body auxiliary bedsheet according to the present invention is attached to a bed, the covering section and a part of the head section are positioned on the upper half portion in the front surface of the bed, and the remaining portions of the bedsheet are positioned on the top-side, left-side and right-side surfaces of the top portion of the bed, or the back-side surface of the bed. A top end portion of the bed is inserted in the bag-shaped part of the bedsheet. This prevents the head section and the covering section from being displaced if a person lying on the bed actively moves. Furthermore, the upper-half-body auxiliary bedsheet covers a wide area of a bed including the front surface of the upper portion, left and right side surfaces, as well as top side surface of the bed, thereby preventing the bed from becoming dirty.

When the upper-half-body auxiliary bedsheet is removed, the connecting member is untied, and then the head section and the left and right folding-back sections are pulled out from the underneath area of the bed, so that the bedsheet is removed from the bed. When a person is lying on the bed, one of the left and right folding-back sections or the head section is pulled so that the bedsheet is drawn out from between the bed and the person.

When the upper-half-body auxiliary bedsheet has become dirty, the bedsheet is removed from a bed in the following steps. The left and right folding-back sections are pulled out from the underneath area of the bed with the connecting members still connecting. One of the left and right folding-back sections (the one with more stains, for example) is folded to roll up toward the covering section with the front surface of the bedsheet inside. When half of the covering section is rolled up, the other one of the folding-back sections is rolled up in the similar manner, and then the rolled-up covering section with the left and right folding-back sections is folded toward the head section. Then, the bag-shaped head section is removed from the head portion of the bed, and the folded portions (i.e., the left and right folding-back sections, and the covering section) are accommodated in the bag-shaped head section.

With this, the upper-half-body auxiliary bedsheet can be removed from the bed, with the stains being kept inside the folded bedsheet, thereby avoiding the stains from adhering to a hand, cloth, or other parts of an operator, and ultimately avoiding the stains from spattering.

It is preferable that left and right wrapping sections each having a width greater than the thickness of a bed are provided in the left and right sides of the head section. The wrapping sections may extend from the entirety of the left and right sides of the head section, or may also extend from the left and right sides of only the portion of the head section which is positioned on the front surface of the bed.

With this configuration, the entirety of the side surfaces of the upper portion of a bed are covered by the upper-half-body auxiliary bedsheet, thereby preventing a wider area of the bed from becoming dirty. In addition, the bed on which the upper-half-body auxiliary bedsheet is put portrays an excellent image.

If the covering section has a waterproof back-side surface, stains do not permeate the back-side surface of the upper-half-body auxiliary bedsheet, to thereby prevent the bed beneath the bedsheet from becoming dirty.

If the covering section has a waterproof bottom side portion and/or waterproof left and right side portions, stains can be prevented from flowing out from the covering section, to thereby prevent a part of the bed, which is not covered by the upper-half-body auxiliary bedsheet, from becoming dirty.

An upper-half-body auxiliary bedsheet according to the present invention developed for solving the previously described problem includes:

a head section having a bag-like shape, for covering a top portion of a bed;

a rectangular covering section extending from the bottom side of the head section, for covering the front surface of the upper half portion of the bed exclusive of the top portion of the bed; and

left and right folding-back sections respectively extending from the left and right sides of the covering section,

wherein the head section is formed in the bag-like shape by holding a single sheet member in a folded form with a holding member.

The holding member may include a plurality of connecting members that connect the left end and the right end of the sheet member folded in the vertical direction. An example of the connecting members is a pair of string members. With this configuration, the size of the head section can be adjusted to the size of a bed, by loosening or tightening the connecting members.

The connecting members may include a pair of string members, or a belt and a belt loop in which the belt is inserted.

In the case of using a belt and a belt loop as the connecting members, a restriction member which prevents the belt that passes through the belt loop from slipping out of the belt loop may be provided, whereby the head section can be surely maintained in the bag-like shape.

The holding member may be a pressure-bonded portion formed by pressure-bonding an end portion of the sheet member that is folded. With this configuration, the head section can be previously shaped in a bag-like form.

### Advantageous Effects of the Invention

An upper-half-body auxiliary bedsheet according to the present invention can be easily removed from and attached to a bed, and surely prevents the bed from becoming dirty.

### BRIEF DESCRIPTION OF DRAWINGS

FIG. 1A is a schematic view showing an upper-half-body auxiliary bedsheet according to a first embodiment of the present invention, and FIG. 1B is a development view of a head section of the auxiliary bedsheet.

FIGS. 2A-2E are explanatory views each showing the steps of the operation of putting the upper-half-body auxiliary bedsheet of the same embodiment on a mattress.

FIGS. 3A-3G are explanatory views each showing the steps of the operation of removing the upper-half-body auxiliary bedsheet of the same embodiment from the mattress.

FIG. 4 is a plan view showing an upper-half-body auxiliary bedsheet according to a second embodiment of the present invention.

FIG. 5 is a plan view showing a modified example of the upper-half-body auxiliary bedsheet according to the second embodiment.

FIG. 6 is a plan view showing another modified example of the upper-half-body auxiliary bedsheet according to the second embodiment.

FIG. 7 is a plan view showing an upper-half-body auxiliary bedsheet according to a third embodiment of the present invention.

FIGS. 8(1)-8(3) are explanatory views showing the steps of the operation of putting, on a mattress, the upper-half-body auxiliary bedsheet according to the third embodiment.

FIG. 9 is a plan view showing an upper-half-body auxiliary bedsheet according to a fourth embodiment of the present invention.

FIGS. 10(1)-10(3) are explanatory views showing the steps of the operation of putting, on a mattress, the upper-half-body auxiliary bedsheet according to the fourth embodiment.

FIG. 11 is a plan view showing an upper-half-body auxiliary bedsheet according to a fifth embodiment of the present invention.

FIGS. 12(1)-12(3) are explanatory views showing the steps of the operation of putting, on a mattress, the upper-half-body auxiliary bedsheet according to the fifth embodiment.

FIG. 13 is a plan view showing an upper-half-body auxiliary bedsheet according to a sixth embodiment of the present invention.

FIG. 14 is a plan view showing an upper-half-body auxiliary bedsheet according to a seventh embodiment of the present invention.

FIG. 15 is a plan view showing an upper-half-body auxiliary bedsheet according to an eighth embodiment of the present invention.

FIG. 16 is a diagram showing the upper-half-body auxiliary bedsheet according to the eighth embodiment, with its head section being developed.

FIG. 17 is a plan view showing a modified example of the upper-half-body auxiliary bedsheet according to the eighth embodiment.

FIG. 18 is a development view of the modified example of the upper-half-body auxiliary bedsheet according to the eighth embodiment.

FIG. 19 is a plan view showing another modified example of the upper-half-body auxiliary bedsheet according to the eighth embodiment.

FIG. 20 is a development view of another above-mentioned modified example of the upper-half-body auxiliary bedsheet according to the eighth embodiment.

FIG. 21 is a plan view showing still another modified example of the upper-half-body auxiliary bedsheet according to the eighth embodiment.

FIG. 22 is a development view of still another above-mentioned modified example of the upper-half-body auxiliary bedsheet according to the eighth embodiment.

FIG. 23 is a perspective view showing a mattress on which an upper-half-body auxiliary bedsheet according to a variation of the present invention is put.

FIG. 24 is a perspective view showing a mattress on which an upper-half-body auxiliary bedsheet according to another variation of the present invention is put.

### DESCRIPTION OF EMBODIMENTS

Embodiments of an upper-half-body auxiliary bedsheet according to the present invention are specifically described as follows. It should be noted that the description of the embodiments proceeds with reference to a person lying on a bed, whose face is up. In this condition, the head section of the person is set to the top, the leg section to the bottom, the right-hand side to the left, and the left-hand side to the right.

### First Embodiment

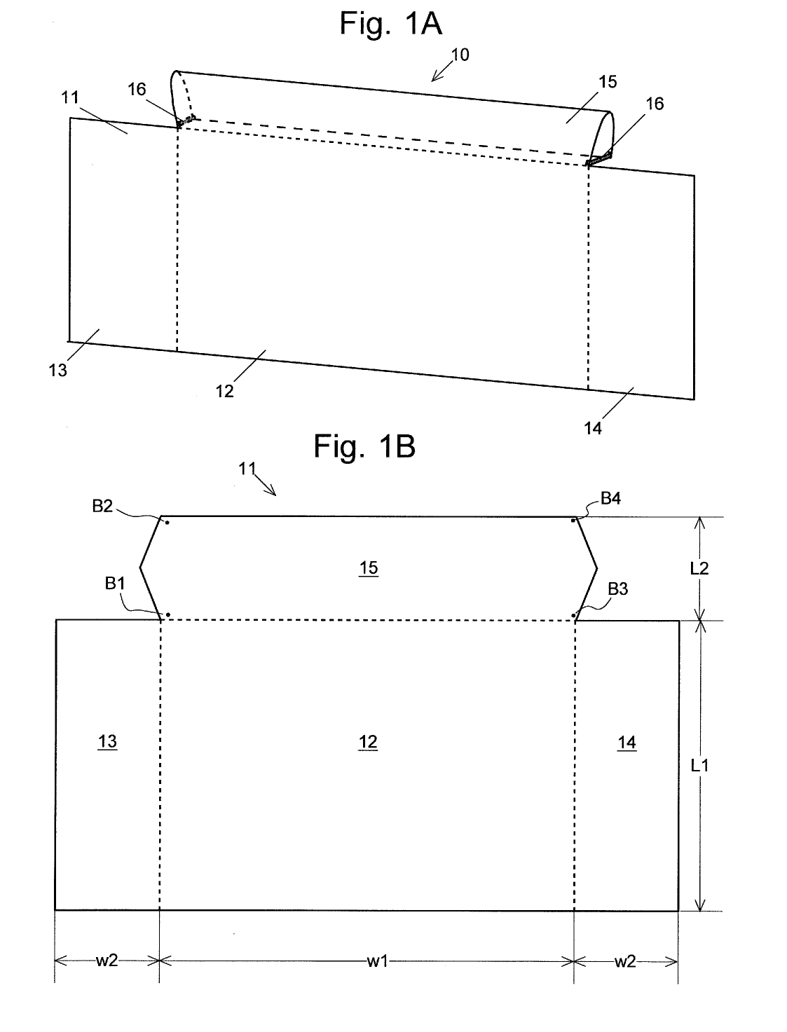

An upper-half-body auxiliary bedsheet (hereinafter, it may be simply referred to as an “auxiliary bedsheet”) 10 according to the first embodiment of the present invention includes a main sheet body 11 and two rubber strings 16, as shown in FIGS. 1A and 1B. The main sheet body 11 is prepared by cutting a single sheet into a predetermined shape, and includes: a rectangular covering section 12 that covers the front surface of a mattress serving as a bed; a left folding-back section 13 and a right folding-back section 14 respectively extending from the left and right sides of the covering section 12; and a head section 15 extending from the top side of the covering section 12.

The main sheet body 11 may be made of a waterproof sheet, such as a waterproof fabric (e.g. a nonwoven fabric, cotton fabric, linen fabric) or waterproof paper. Such sheets include, for example, a waterproof polyolefin-based nonwoven fabric or a waterproof cellulosic-based nonwoven fabric, which are used as materials for “Multi-layer stretcher sheet” (that is a trade name, and is produced by Medline Industries Japan GK) commonly used as operation bedsheets in medical sites. The main sheet body 11 that has a waterproof property can prevent stains attached to the front surface of the auxiliary bedsheet 10 from permeating into a mattress.

The main sheet body 11 includes a front surface and a back-side surface, which may be different in material. The front surface may be made of a material having absorbability, such as a nonwoven fabric or pile fabric (such as a towel). The back-side surface may be made of a material having a waterproof property, such as a polyethylene film or polypropylene film. The front surface is made of the material having absorbability, thereby providing the auxiliary bedsheet 10 with an excellent touch. Such a material includes, for example, “Under Pad C” (which is a trade name, and is produced by NIPPON SIGMAX Co., Ltd.).

The material for the main sheet body 11 may be appropriately selected according to the type of bed which the auxiliary bedsheet 10 is put on, an application purpose, and so on.

The covering section 12 has: a width w1 with a length approximately the same as the width of a mattress; and a length L1 set to be slightly shorter than half the length of the mattress. The covering section 12 has the length L1 set to such a length. Accordingly, when a person lies down on a mattress on which the covering section 12 is put, the bottom side of the covering section 12 is located at around his/her shoulder joint, or waist.

The left and right folding-back sections 13 and 14 each have a substantially rectangular shape, and have a width w2 set to two to three times the thickness of the mattress. The width w2 has any length that is greater than the thickness of the mattress, and is not particularly limited in its length. Here, if the length of the width w2 is shorter than two times the thickness of the mattress, the auxiliary bedsheet 10 put on the mattress easily comes off. If the width w2 is greater than three times the length of the thickness of the mattress, it is difficult to put the auxiliary bedsheet 10 on the mattress.

The head section 15 covers the top portion of a mattress. The head section 15 is prepared by folding a hexagonal portion so as to define a bag-like shape. In each of the left and right sides of the hexagonal portion, a rubber string 16 is stretched between the top and bottom ends of the hexagonal portion. The hexagonal portion has a length L2 that is long enough to prevent the head section 15 from being detached immediately being put on the head portion of the mattress, and is short enough for the head section 15 to be easily put on the head portion of the mattress on which a person is lying. Specifically, the length L2 is set to be 20 to 50 cm greater than the thickness of the mattress.

The two rubber strings 16 serve as a connecting member or a holding member in the present invention. One of the two rubber strings 16 has one end sewn on a site (B1 in FIG. 1B) at around a left end portion in the top side of the covering section 12, and the other end sewn on a site (B2 in FIG. 1B) at around a left end portion in the top of the head section 15. The other rubber string 16 has one end sewn on a site (B3 in FIG. 1B) at around a right end portion in the top side of the covering section 12, and the other end sewn on a site (B4 in FIG. 1B) at around a right end portion in the top of the head section 15. When the bag-shaped head section 15 is put on a mattress, the rubber springs 16 are stretched out. After the head section 15 is put on the mattress, the head section 15 is fixedly attached to the top portion of the mattress by the elastic force of the rubber springs 16.

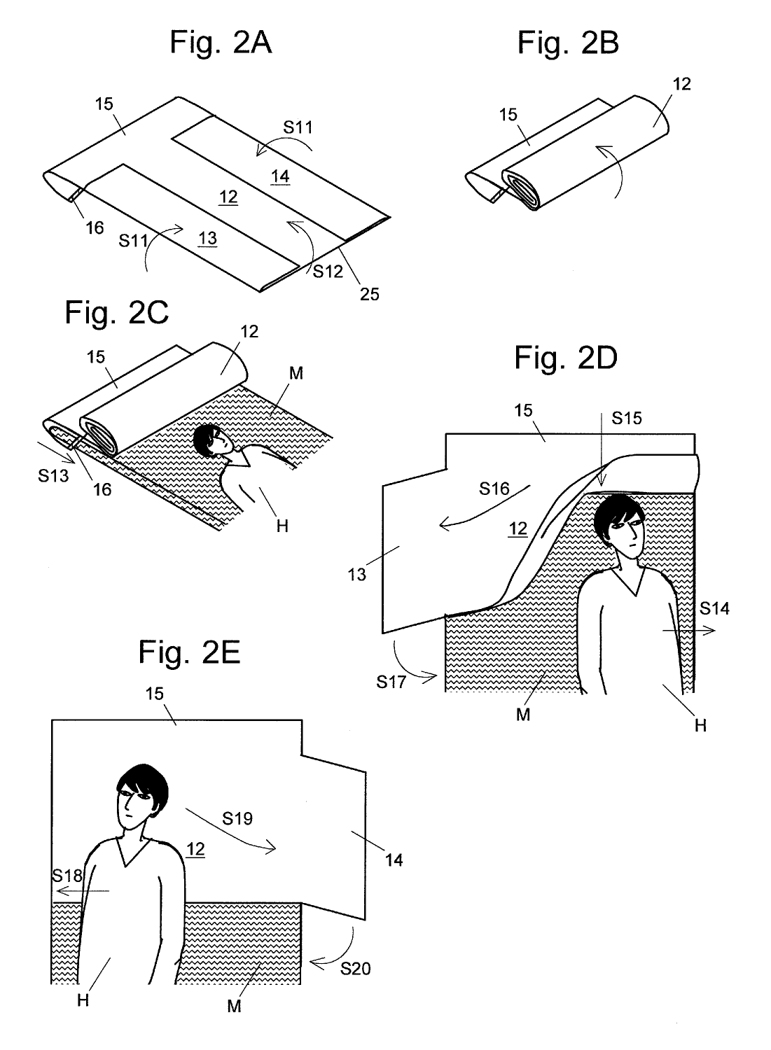

Operations of putting the auxiliary bedsheet 10 having the previously mentioned structure on a mattress M where a person H is lying on with his/her face up are described with reference to FIGS. 2A-2E. It should be noted that the numbers written together with the letter “S” indicate the order of the operations, and arrows beside these numbers indicate the movement of the auxiliary bedsheet 10 in each of the operations.

First, the left and right folding-back sections 13 and 14 are folded and stacked on the covering section 12 (S11 in FIG. 2A). The auxiliary bedsheet 10 is folded or rolled from the bottom side to the top side of the covering section 12, with its front surface inside (S12 in FIG. 2A, and FIG. 2B). The rubber strings 16 are stretched out in this situation, and the head section 15 is overlaid on a top portion of the mattress M (S13 in FIG. 2C). Then, the stretching out of the rubber strings 16 is stopped, whereupon the head section 15 of the auxiliary bedsheet 10 is fixedly attached to the mattress M by the elastic force of the rubber springs 16.

Next, the person H is moved to a side close to the right end of the mattress M (S14 in FIG. 2D) to leave a space in the left half of the mattress M. In the left space, the covering section 12 is spread (S15 and S16 in FIG. 2D), and then the folding-back section 13 is folded and inserted under the mattress M (S17 in FIG. 2D). Subsequently, the person H is moved to a side close to the left end of the mattress M (S18 in FIG. 2E) to leave a space in the right half of the mattress M. In the left space, the covering section 12 is spread (S19 in FIG. 2E), and then the folding-back section 14 is folded and inserted under the mattress M (S20 in FIG. 2E).

As aforementioned, the auxiliary bedsheet 10 according to the present embodiment does not have a bag-like shape in its left and right side portions. This eliminates the necessity of covering the entirety of the mattress M with a bedsheet at once, and allows a bedsheet to be partially put on the mattress each step. Accordingly, the bedsheet can be easily put on the mattress M even when the person H is lying on the mattress M. Furthermore, the head section 15 is fixedly attached to the mattress M at the beginning, so that the bedsheet hardly becomes displaced upon being put on the mattress as well as during its usage.

The auxiliary bedsheet 10 according to the present embodiment adopts the rubber strings 16 having a stretching property, as the connecting member of the head section 15. With this, the head section 15 of the auxiliary bedsheet 10 can be fixedly attached to the top portion of the mattress even when the width w1 of the head section 15 is slightly less or greater than the width of the mattress M. The folding-back sections 13 and 14 of the auxiliary bedsheet 10 are not shaped like a bag, and remain to be shaped like sheet, so as to appropriately cover the front and side surfaces of the mattress M. The head section 15 has an approximately hexagonal shape having an expanded width at an area that covers the top portion of the mattress M. With this, the auxiliary bedsheet 10 can appropriately cover the top portion of the mattress M, even when the width w1 of the head section 15 is slightly smaller than the width of the mattress M.

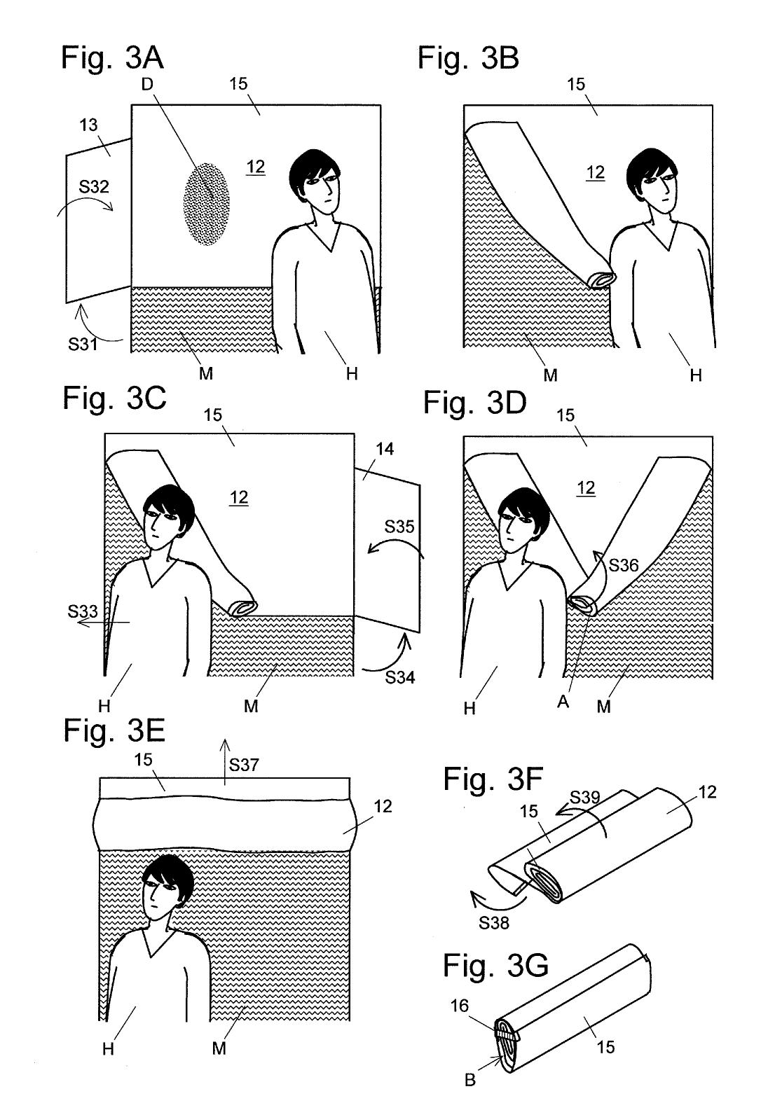

Operations of removing the auxiliary bedsheet 10 from the mattress M are described with reference to FIGS. 3A-3G. It should be noted that the description proceeds under the situation where the person H is lying on the right side of the mattress M, and a stain D is adhered to the left side of the auxiliary bedsheet 10 (FIG. 3A).

First, the left folding-back section 13 is pulled out from the underneath area of the mattress M (S31 in FIG. 3A). Then, the folding-back section 13 and the covering section 12 that continues the folding-back section 13 are rolled or folded, with the front surface of the covering section 12 inside, so as to be peeled off from the mattress M (S32 in FIG. 3A). Alternatively, the folding-back section 13 may be first folded to keep the site to which the stain D adheres out of the sight, and then the covering section 12 may be rolled. Since the head section 15 is fixedly attached to the mattress M, the covering section 12 is folded with a larger length in its left lower half than in its left upper half After the site to which the stain D adheres has been completely covered by the folded covering section 12 (FIG. 3B), the person H is allowed to move to the left side of the mattress M (S33 in FIG. 3C).

Subsequently, the right folding-back section 14 is pulled out from the underneath area of the mattress M (S34 in FIG. 3C). Then, the folding-back section 14 and the covering section 12 that continues the folding-back section 14 are rolled, with the front surface of the covering section 12 inside (S35 in FIG. 3C). When the remaining site of the covering section 12, which is not folded, is shaped in substantially a triangle (FIG. 3D), the covering section 12 is folded toward the head section 15 (S36 in FIG. 3D). Upon completion of folding the covering section 12 above the head of the person H, the bag-shaped portion of the head section 15 is pulled out from the top portion of the mattress M (S37 in FIG. 3E). Then, the bag-shaped portion of the head section 15 is turned inside out to hold the folded portion in it (i.e., the left and right folding-back sections 13 and 14, and the covering section 12) (S38 and S39 in FIGS. 3F and 3G).

As aforementioned, the auxiliary bedsheet 10 has the folding-back sections 13 and 14 that are not shaped like a bag. Accordingly, the folding-back sections 13 and 14 can be easily pulled out from the underneath area of the mattress M even when the person H is lying on the mattress M. Furthermore, the auxiliary bedsheet 10 can be removed from the mattress M while being folded with the stain D adhered to the auxiliary bedsheet 10 hidden inside. This prevents the stain D from being spattered, or from adhering to the body or clothes of the person H on the mattress M and the hands or clothes of an operator. In addition, the folded portion is held in the bag-shaped portion of the head section 15, so as to keep the auxiliary bedsheet 10 in a folded state. Accordingly, even if the removed auxiliary bedsheet 10 is left for a while, and another operation is carried out, the stain 10 that adheres to the auxiliary bedsheet 10 is not exposed. The auxiliary bedsheet 10 does not become bulky upon disposal. Accordingly, the auxiliary bedsheet 10 is suitable as a disposable bedsheet.

### Second Embodiment

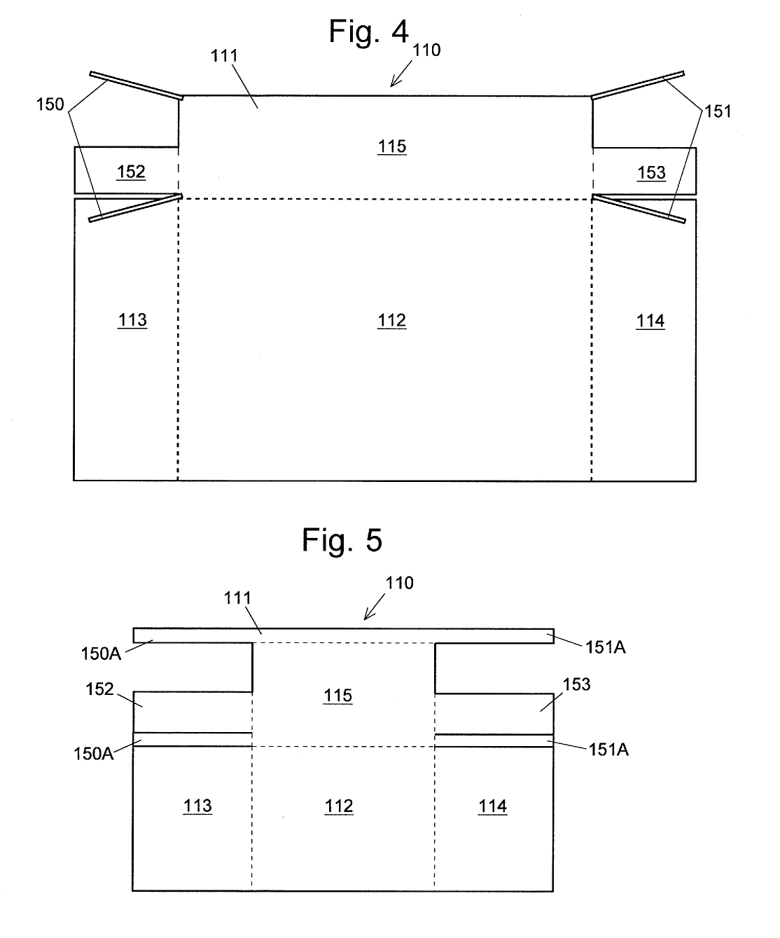

FIG. 4 is a plan view showing an upper-half-body auxiliary bedsheet (which is hereinafter referred to as an “auxiliary bedsheet”) 110 according to the second embodiment. Portions the same as or corresponding to those of the auxiliary bedsheet 10 according to the first embodiment are denoted by numbers whose last two figures are the same with those in the first embodiment, and the description for them is appropriately omitted.

The auxiliary bedsheet 110 includes a main sheet body 111 and two pairs of tie strings 150 and 151. The main sheet body 111 includes: a rectangular covering section 112; a rectangular head section 115 extending from the top side of the covering section 112; a left wrapping section 152 and a right wrapping section 153 individually extending from lower half portions of the left and right sides of the head section 115; and a rectangular left folding-back section 113 and a rectangular right folding-back section 114 respectively extending from the left and right sides of the covering section 12.

The two pairs of tie strings 150 and 151 are each adhered with an adhesive to the top and bottom of each of the left and right sides of the head section 115. The length of the tie strings 150 and 151 is, for example, set to be substantially the same as the width of the folding-back sections 113 and 114 (approximately two to three times the thickness of a mattress).

The auxiliary bedsheet 110 is put on a mattress as follows.

First, the head section 115 is folded in half toward the back side. Then, the two tie strings of each of the pairs are tied. More specifically, the two tie strings are tied so that the total length of the tied strings is approximately equal to the thickness of the mattress. With this, the head section 115 of the auxiliary bedsheet 110 is formed in a bag-like shape. The auxiliary bedsheet 110 can be thus put on the mattress with the steps similar to those (S11 to S20) for the auxiliary bedsheet 10 according to the first embodiment. In the last step, the left and right wrapping sections 152 and 153 are folded and inserted under the mattress, as with the left and right folding-back sections 113 and 114.

The auxiliary bedsheet 110 thus put on the mattress can be removed from the mattress without untying the knots of the two pairs of tie strings 150 and 151; it can be removed by steps similar to the first embodiment (S32 to S39) while maintaining the head section 115 in the bag-like shape.

As aforementioned, the auxiliary bedsheet 110 according to the present embodiment has the head section 115 that is shaped like a bag by tying each of the two pairs of tie strings 150 and 151. This allows the auxiliary bedsheet 110 to be applied to mattresses with various levels of thickness. The head section 115 and the wrapping sections 152 and 153 in the left and right sides of the head section 115 cover the entirety of the top portion of a mattress. This further prevents the mattress from becoming dirty.

The auxiliary bedsheet 110 can also be removed from the mattress by: untying the knots of the two pairs of tie strings 150 and 151; pulling the head section 115, the left and right wrapping sections 152 and 153, as well as the left and right folding-back sections 113 and 114 out from the underneath area of the mattress; and then drawing the bedsheet from its left, right or bottom side in an appropriate direction.

Furthermore, the auxiliary bedsheet 110 according to the present embodiment can also be put on a mattress as follows: First, the covering section 112 and the lower half of the head section 115 are spread over the upper half portion of the mattress. Subsequently, the remaining (upper-half) portion of the head section 115 and the left and right folding-back sections 113 and 114 are folded and inserted under the mattress. The tie strings 150 and 151 in each of the two pairs in the respective left and right sides of the mattress are tied according to the thickness of the mattress, and then the left and right wrapping sections 152 and 153 are folded and inserted under the mattress.

The steps of putting on and removing the auxiliary bedsheet 110 may be determined depending on the situation, e.g. according to whether a person is lying on a bed or considering the position of the auxiliary bedsheet 110 where stains are adhered.

FIG. 5 shows a modified example of the auxiliary bedsheet 110 according to the second embodiment. In the example, the main sheet body 111 and two pairs of tie strings 150A and 151A are integrally formed. Such an auxiliary bedsheet 110 can be produced by performing a cutting-out process on a single sheet made of a nonwoven fabric.

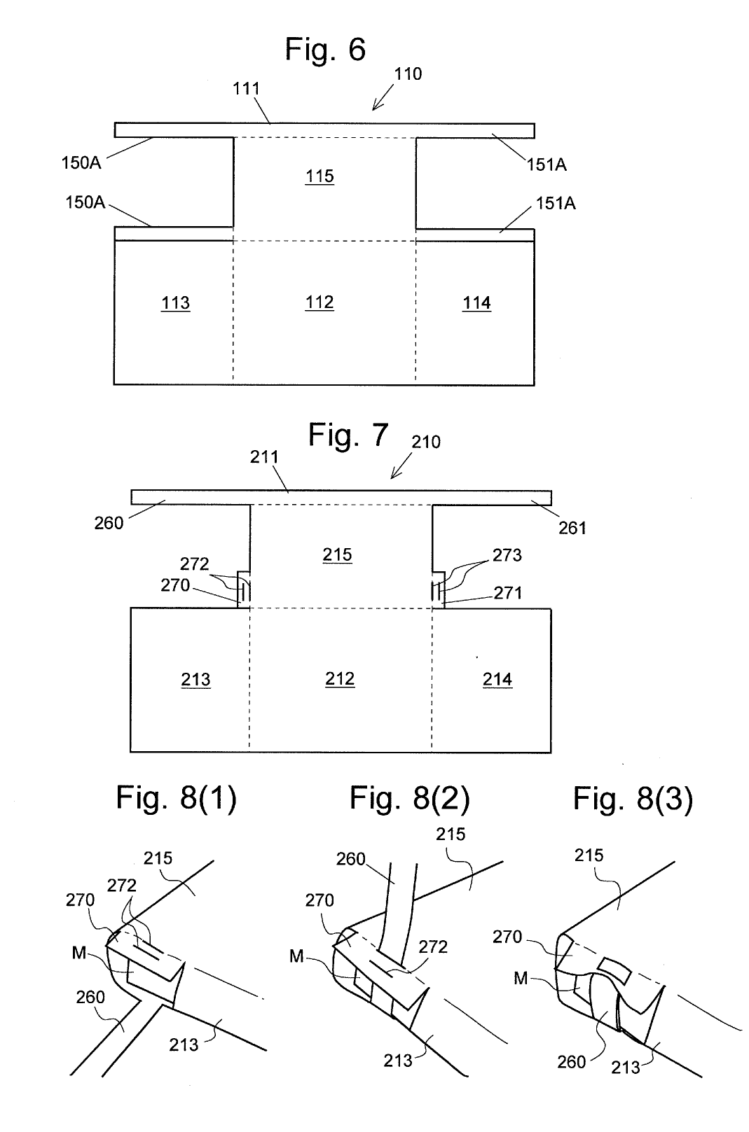

FIG. 6 shows another modified example of the auxiliary bedsheet according to the second embodiment. This example relates to the same type of auxiliary bedsheet as the bedsheet shown in FIG. 5, except that wrapping sections in the left and right sides are omitted. Accordingly, the main sheet body 111 and the two pairs of strings 150A and 151A are also integrally formed in this example.

The aforementioned two modified examples eliminates the necessity of adhering the tie strings to the main sheet body 111, thereby keeping the production cost low.

### Third Embodiment

FIG. 7 is a plan view showing an upper-half-body auxiliary bedsheet (which is hereinafter simply referred to as an “auxiliary bedsheet”) 210 according to the third embodiment. Portions the same as or corresponding to those of the auxiliary bedsheet 110 according to the second embodiment are denoted by numbers whose last two figures are the same as those in the second embodiment, and the description for them is appropriately omitted.

The auxiliary bedsheet 210 is prepared by performing a punching process on a single sheet of nonwoven fabric, and includes a main sheet body 211, two tightening belts 260 and 261, and belt loops 270 and 271. The main sheet body 211 includes: a rectangular covering section 212; a rectangular head section 215 extending from the top side of the covering section 212; and a left folding-back section 213 and a right folding-back section 214 respectively extending from the left and right sides of the covering section 212.

The two tightening belts 260 and 261 respectively extend from the top portions of the left and right sides of the head section 215, and each have the length approximately three to five times the thickness of a mattress, for example.

The belt loops 270 and 271 respectively protrude from the bottom portions of the left and right sides of the head section 215, and each have two slits 272 or 273 all of which have a length substantially the same as the width of each of the tightening belts 260 and 261.

The auxiliary bedsheet 210 is put on the mattress M in the steps shown in FIGS. 8(1)-8(3).

First, the covering section 212 and the lower half of the head section 215 are spread over the upper half portion of the mattress M. Subsequently, the upper half of the head section 215 and the left and right folding-back sections 213 and 214 are folded and inserted under the mattress M (FIG. 8(1)). The tightening belts 260 and 261 respectively are passed through the inner (close to the head section 215) slits 272 and 273 of the belt loops 270 and 271, from the back side to the front side of the auxiliary bedsheet 210 (FIG. 8(2)). Subsequently, the tightening belts 260 and 261 respectively passing through the inner slits 272 and 273 are allowed to respectively pass through the outer slits 272 and 273 of the belt loops 270 and 271 from the front side to the back side of the auxiliary bedsheet 210, and then are folded and inserted under the mattress M (FIG. 8(3)). With these steps, the auxiliary bedsheet 210 is put on the mattress M.

The auxiliary bedsheet 210 thus put on the mattress M can be removed from the mattress M by steps similar to the first embodiment (S32 to S39).

In the auxiliary bedsheet 210 according to the present embodiment, the tightening belts 260 and 261 respectively pass through the slits 272 and 273 of the belt loops 270 and 271, allowing the head section 215 to be shaped like a bag. This simplifies the operation of putting the auxiliary bedsheet 210 on the mattress M.

### Fourth Embodiment

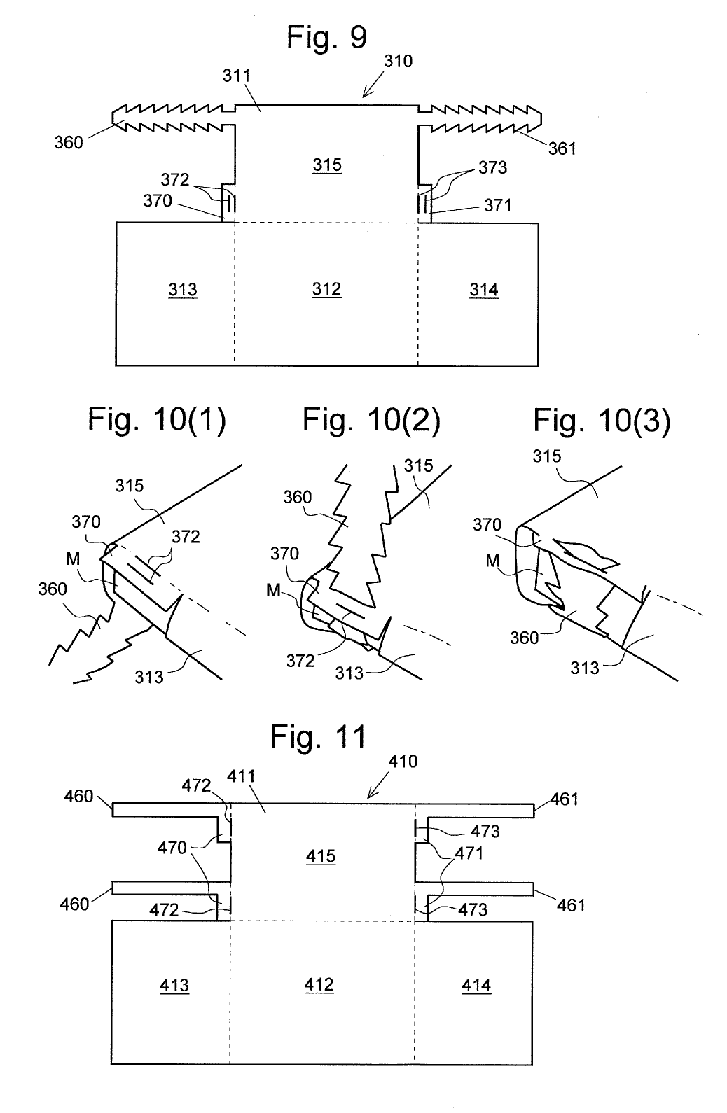

FIG. 9 is a plan view showing an upper-half-body auxiliary bedsheet (which is hereinafter simply referred to as an “auxiliary bedsheet”) 310 according to the fourth embodiment. Portions the same as or corresponding to those in the auxiliary bedsheet 210 according to the third embodiment are denoted by numbers whose last two figures are the same as those in the third embodiment.

The auxiliary bedsheet 310 is prepared by performing a punching process on a single sheet of nonwoven fabric, like the auxiliary bedsheet 210, and includes a main sheet body 311, two tightening belts 360 and 361, and belt loops 370 and 371. The main sheet body 311 includes: a rectangular covering section 312; a rectangular head section 315 extending from the top side of the covering section 312; and a left folding-back section 313 and a right folding-back section 314 respectively extending from the left and right sides of the covering section 312.

The two tightening belts 360 and 361 respectively extend from the top portions of the left and right sides of the head section 315, and each have a length approximately three to five times the thickness of a mattress, for example.

The tightening belts 360 and 361 each have edge portions with a saw-tooth shape. This prevents the tightening belts 360 and 361 having respectively passed through slits 372 and 373 in belt loops 370 and 371 from being pulled out from the slits 372 and 373. Accordingly, in the present embodiment, the tightening belts 360 and 361 themselves correspond to the restriction members of the present invention.

FIGS. 10(1) to 10(3) show steps of putting the auxiliary bedsheet 310 on the mattress M. Basic operations are the same as those for the auxiliary bedsheet 210 according to the third embodiment.

Here, in the auxiliary bedsheet 310, the tightening belts 360 and 361 each have the saw-tooth edge portions. This prevents the tightening belts 360 and 361 having respectively passed through the slits 372 and 373 in the belt loops 370 and 371 from being loosened. Therefore, the head section 315 can be fixedly attached to the top portion of the mattress M.

### Fifth Embodiment

FIG. 11 is a plan view showing an upper-half-body auxiliary bedsheet (which is hereinafter simply referred to as an “auxiliary bedsheet”) 410 according to the fifth embodiment. Portions the same as or corresponding to those of the auxiliary bedsheet 210 according to the third embodiment are allocated with numbers whose last two figures are the same as those in the third embodiment.

The auxiliary bedsheet 410 is prepared by performing a punching process on a single sheet of nonwoven fabric, like the auxiliary bedsheet 210, and includes a main sheet body 411, two pairs of tightening belts 460 and 461, and two pairs of belt loops 470 and 471.

Specifically, the belt loops 470 are individually formed in the upper and lower end portions of the left side of the head section 415. Each of the tightening belts 460 is integrally formed with the corresponding one of the belt loops 470. Meanwhile, the belt loops 471 are individually formed in the upper and lower end portions of the right side of the head section 415. Each of the tightening belts 461 extends from the corresponding one of the belt loops 471. The belt loops 470 and 471 are respectively provided with slits 472 and 473 having a length the same as the width of each of the tightening belts 460 and 461.

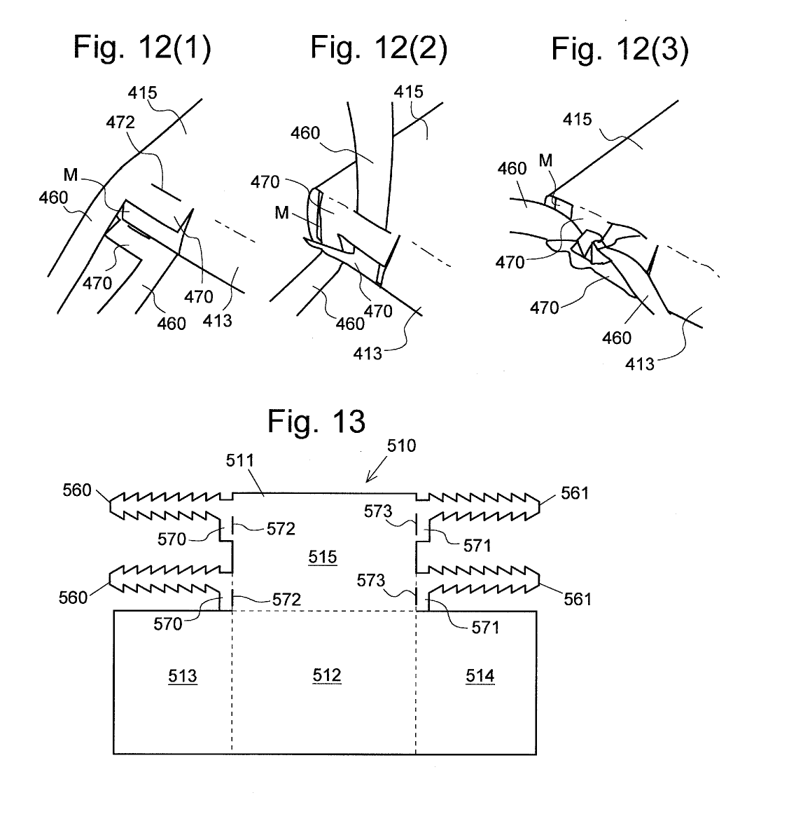

FIGS. 12(1) to 12(3) show steps of putting the auxiliary bedsheet 410 on the mattress M.

First, the covering section 412 and the lower half of the head section 415 are spread over the upper half portion of the mattress M. Subsequently, the upper half of the head section 415 and the left and right folding-back sections 413 and 414 are folded and inserted under the mattress M (FIG. 12(1)). With this, one of the two tightening belts 460 and one of the two belt loops 470 on one side, as well as one of the tightening belts 461 and one of the belt loops 471 on the other side, are positioned under the mattress M, whereas each of the remaining ones is positioned in the front-surface side of the mattress M.

Subsequently, the tightening belts 460 and 461 positioned in the front-surface side of the mattress M are allowed to respectively pass through, from the bottom to the upside, the slits 472 and 473 in the corresponding belt loops 470 and 471 positioned in the back side of the mattress M. Similarly, the tightening belts 460 belts 461 which are positioned in the back side of the mattress M are allowed to respectively pass through, from the upside to the bottom, the slits 472 and 473 in the corresponding belt loops 470 and 471 positioned in the front-surface side of the mattress M (FIG. 12(2)).

The two tightening belts 460 individually passing through each of the two slits 472 are tied together, and the two tightening belts 461 individually passing through each of the two slits 473 are also tied together (FIG. 12(3)). With these steps, the auxiliary bedsheet 410 is put on the mattress M.

The auxiliary bedsheet 410 put on the mattress M can be removed from the mattress M by steps similar to the first embodiment (S32 to S39).

In the auxiliary bedsheet 410, the tightening belts 460 and 461 are respectively passed through the slits 472 and 473 in the belt loops 470 and 471, and then the tightening belts 460 or 461 on each side are tied together. Although this causes the operation of putting the auxiliary bedsheet 410 on the mattress M to take a little time, the auxiliary bedsheet 410 can be fixedly attached to the mattress M.

### Sixth Embodiment

FIG. 13 is a plan view showing an upper-half-body auxiliary bedsheet (which is hereinafter simply referred to as an “auxiliary bedsheet”) 510 according to the sixth embodiment. Portions the same as or corresponding to those in the auxiliary bedsheet 410 according to the fifth embodiment are denoted by numbers whose last two figures are the same as those in the fifth embodiment.

The auxiliary bedsheet 510 has the same configuration as that of the auxiliary bedsheet 410 according to the fifth embodiment, except that the tightening belts 560 and 561 each have edge portions with a saw-tooth shape. Accordingly, the operation of putting the auxiliary bedsheet 510 on a mattress includes approximately the same steps as those in the fifth embodiment. The tightening belts 560 and 561 with the saw-tooth edge portions enables the auxiliary bedsheet 510 to be put on a mattress more firmly.

### Seventh Embodiment

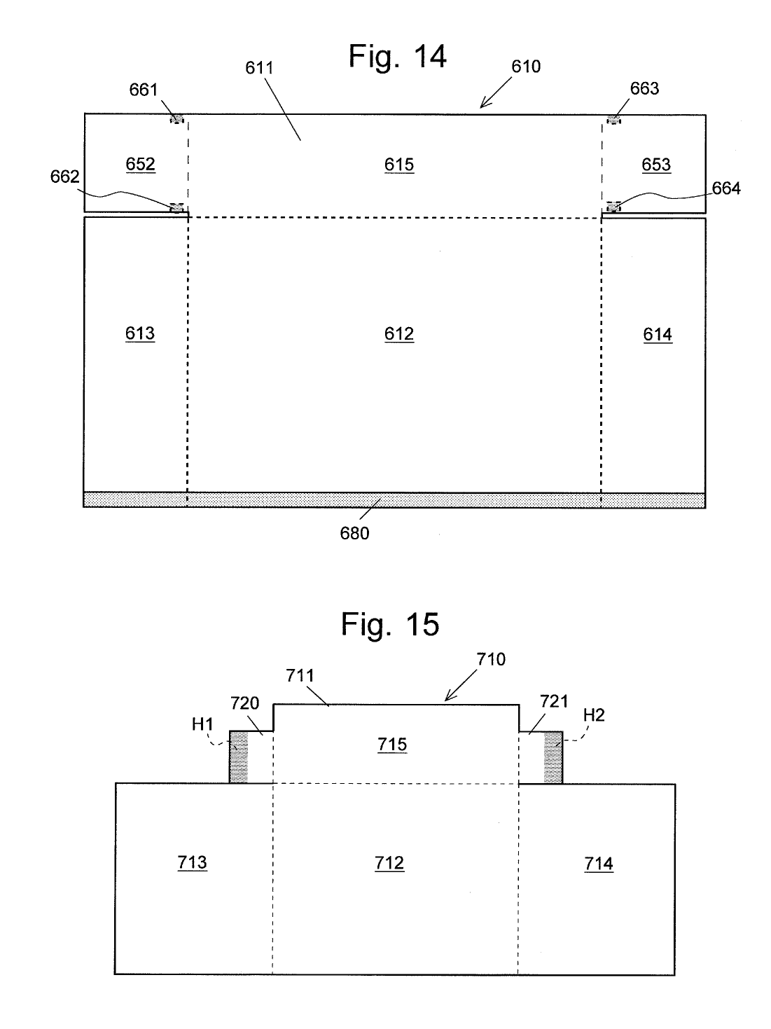

FIG. 14 is a plan view showing an upper-half-body auxiliary bedsheet (which is hereinafter simply referred to as an “auxiliary bedsheet”) 610 according to the seventh embodiment. Portions the same as or corresponding to those in the auxiliary bedsheet 110 according to the second embodiment are denoted by numbers whose last two figures are the same as those in the second embodiment, and the description for them is appropriately omitted.

The auxiliary bedsheet 610 includes: a front surface made from an absorbent sheet, such as a pile fabric; and a back-side surface made from a waterproof sheet, such as a polypropylene sheet.

The auxiliary bedsheet 610 includes: a rectangular covering section 612; a left folding-back section 613 and a right folding-back section 614 respectively extending from the left and right sides of the covering section 612; a head section 615 extending from the top side of the covering section 612; and a left wrapping section 652 and a right wrapping section 653 respectively extending from the left and right sides of the head section 615.

The hook piece 661 and loop piece 662 of a hook-and-loop fastener are respectively sewn to the top and bottom end portions of the back-side surface of the left wrapping section 652, in the vicinity of the boundary with the head section 615. Similarly, the hook piece 663 and loop piece 664 of another hook-and-loop fastener are respectively sewn to the top and bottom end portions of the back-side surface of the right wrapping section 653, in the vicinity of the boundary with the head section 615.

A waterproof band 680 having a predetermined width is formed in the bottom end portion of the covering section 612 and the left and right folding-back sections 613 and 614. The waterproof band 680 is formed by folding the bottom end portion of the main sheet body 611 toward the front surface, and sewing the folded section. Since the back-side surface of the main sheet body 611 is made of a waterproof material, the waterproof material in the back-side surface is exposed to the outside at the folded section.

As aforementioned, the auxiliary bedsheet 610 adopts the hook-and-loop fastener in place of the tie strings 150 in the auxiliary bedsheet 110 according to the second embodiment, thereby easily forming the head section 615 in the shape of a bag.

The waterproof band 680 provided in the bottom end portion of the main sheet body 611 prevents a stain from flowing out to the mattress from the covering section 612, even when a liquid-type stain adheres onto the covering section 612.

Furthermore, the length of the wrapping sections 652 and 653 is set to approximately the same as the length of the head section 615. Thus, the front surface and side surfaces of the top portion of the mattress are covered by the head section 615 and the wrapping sections 652 and 653. The remaining front surface and side surfaces of the upper half portion of the mattress are covered by the covering section 612 and the folding-back sections 613 and 614, thereby surely preventing stains from adhering to the mattress. The entirety of the upper half portion of the mattress is completely covered by the auxiliary bedsheet 610, resulting in an excellent appearance.

### Eighth Embodiment

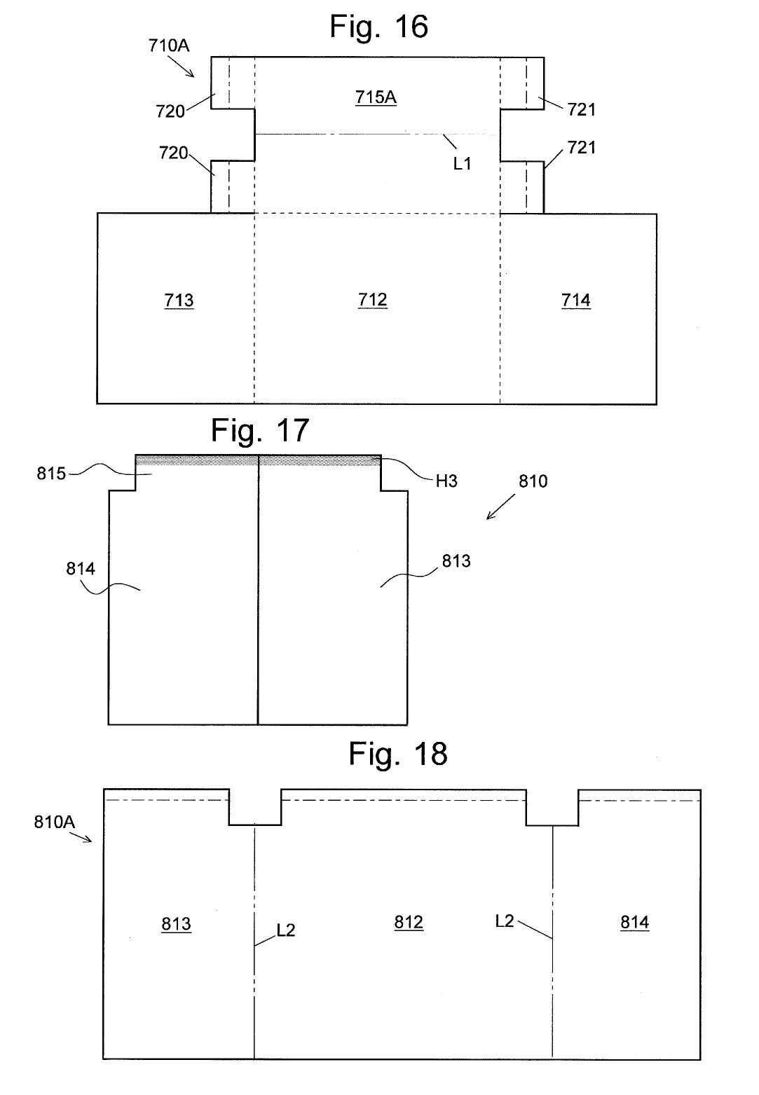

FIG. 15 is a plan view showing an upper-half-body auxiliary bedsheet (which is hereinafter simply referred to as an “auxiliary bedsheet”) 710 according to the eighth embodiment. FIG. 16 is a developed view of the auxiliary bedsheet 710. Portions the same as or corresponding to those in the auxiliary bedsheet 10 according to the first embodiment are denoted by numbers whose last two figures are the same as those in the first embodiment, and the description for them is appropriately omitted.

The auxiliary bedsheet 710 is different from the bedsheet in the first embodiment in that the bag-shaped head section 715 is previously formed by performing a sealing process on a sheet member 710A.

The sheet member 710A is prepared by performing a cutting-out process on a single sheet of nonwoven fabric, and includes: a covering section 712; left and right folding-back sections 713 and 714; a head section-developed portion 715A; two sealing portions 720 positioned at the upper and lower portions in the left side of the head section-developed portion 715A; and two sealing portions 721 positioned at the upper and lower portions in the right side of the head section-developed portion 715A.

The head section-developed portion 715A of the sheet member 710A is folded in half along the alternate long and two short dashed line L1, and the sealing portions 720 are thermally compressed to each other, as well as the sealing portions 721 are thermally compressed to each other (FIG. 15 shows sites H1 and H2 that are thermally compressed. The thermally compressed sites H1 and H2 individually correspond to the holding member in the present invention.) As a result, the bag-shaped head section 715 is formed.

The auxiliary bedsheet 710 having such a configuration is put on a bed as follows:

First, the head section 715 is overlaid on the top portion of the bed. Subsequently, the covering section 712 is spread over the bed, and each of the left folding-back section 713 and the right folding-back section 714 is folded and inserted under the bed.

As aforementioned, the present embodiment eliminates the necessity of tying strings together, or the necessity of allowing a belt to pass through a belt loop, for making the head section 715 in the shape of a bag.

Other examples of the upper-half-body auxiliary bedsheet in which a bag-shaped head section is previously formed by the sealing processing are shown in FIGS. 17 to 22.

The auxiliary bedsheet 810 shown in FIG. 17 is prepared by folding a sheet member 810A shown in FIG. 18 along the alternate long and two short dashed lines L2, and by performing thermocompression bonding on its top portion. In this example, an area corresponding to a left head section in the sheet member 810A continues to the left folding-back section 813, and an area corresponding to a right head section continues to the right folding-back section 814. Accordingly, when the sheet member 810A is folded along the alternate long and two short dashed lines L2, the head section 815 is formed, with the folding-back sections 813 and 814 positioned in the back side of the auxiliary bedsheet 810. As a result, the auxiliary bedsheet 810 that covers almost the entire front surface and back-side surface of the upper half portion of a mattress is completed.

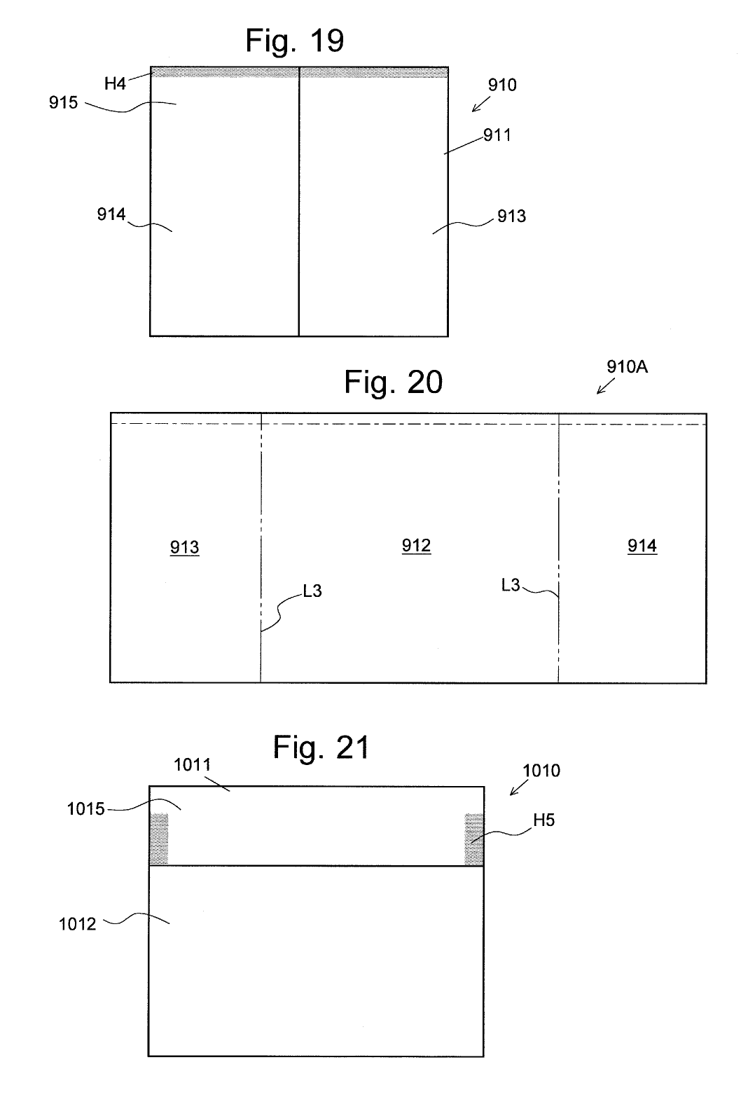

The auxiliary bedsheet 910 shown in FIG. 19 is prepared by folding a sheet member 910A shown in FIG. 20 along the alternate long and two short dashed lines L3, and by performing thermocompression bonding on the top portion of the sheet member 910A (FIG. 19 shows the site H4 that is thermally compressed and bonded). The auxiliary bedsheet 910 also covers almost the entire front surface and back-side surface of the upper half portion of a mattress, in a similar manner to the auxiliary bedsheet 810.

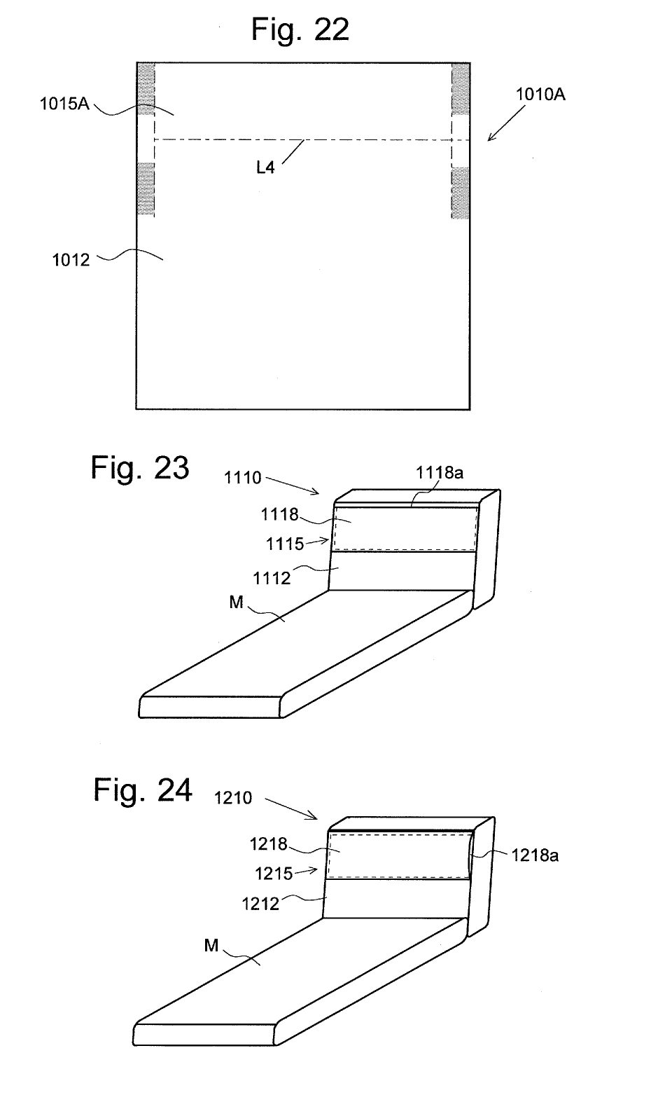

The auxiliary bedsheet 1010 shown in FIG. 21 is prepared by folding a head section-developed portion 1015A in a sheet member 1010A shown in FIG. 22 along the alternate long and two short dashed line L4, and by performing thermocompression bonding on left and right side portions of the folded section, so as to form a head section 1015 (FIG. 21 shows the sites H5 that are thermally compressed and bonded). The auxiliary bedsheet 1010 is a simple type bedsheet, which includes the head section 1015 that extends from the top side of a covering section 1012, but include no folding-back sections in the left and right sides of the covering section 1012. The head section 1015 is overlaid on the top portion of a mattress, and then the covering section 1012 is spread over the mattress, thereby putting the bedsheet on the mattress.

The upper-half-body auxiliary bedsheets described in the previous embodiments are mere examples of the present invention. Any modification, correction, or addition is permitted within a range of the subject matter of the present invention.

The aforementioned auxiliary bedsheets can be provided with a pocket for receiving a pillow. As a specific example, an auxiliary bedsheet 1110 shown in FIG. 23 is provided with a pocket 1118 for receiving a pillow, at the head section 1115. The pocket 1118 has an opening 1118a in its top, through which a pillow is inserted. An auxiliary bedsheet 1210 shown in FIG. 24 is provided with a pocket 1218 for receiving a pillow, at the head section 1215. The pocket 1218 has an opening 1218a in its side, through which a pillow is inserted.

Any material that is used for a typical bedsheet or a draw sheet can be used for material of the main sheet body. The material may have a stretching property. In such a case, if the auxiliary bedsheet is slightly smaller than a mattress in size, the auxiliary bedsheet can be stretched out for usage. In particular, for an auxiliary bedsheet having a bag-shaped head section formed by thermocompression bonding, it is preferable to use a fabric, paper, or nonwoven fabric which has a stretching property, as the sheet member.

In the third embodiment, a waterproof band may also be provided in portions of the covering section which correspond to the left and right sides of a bed. This prevents stains from spreading beyond the portions of the covering section which correspond to the left and right sides of the bed.

The connecting member is not particularly limited to a rubber spring, a pair of tie strings, or a hock-and-loop fastener; it may be any member with which a bag-shaped head section can be formed. For example, the connecting member may be a button and a button hole. The means used for attaching the connecting member to an auxiliary bedsheet is not limited to sewing and adhesion. For example, a stapler can be used for the attachment. More preferably, the attaching means provides the connecting member with an adjustable length to allow for a slight variation in the thickness and width of a mattress.

### REFERENCE SIGNS LIST

10, 110, 210, 310, 410, 510, 610, 710, 810, 910, 1010, 1110, 1210 . . . Upper-Half-Body Auxiliary Bedsheet
11, 111, 211, 311, 411, 511, 611, 711, 911, 1011 . . . Main Sheet Body
12, 112, 212, 312, 412, 512, 612, 712, 812, 912, 1012, 1112, 1212 . . . Covering Section
13, 113, 213, 313, 413, 513, 613, 713, 813, 913 . . . Left Folding-Back Section
14, 114, 214, 314, 414, 514, 614, 714, 814, 914 . . . Right Folding-Back Section
15, 115, 215, 315, 415, 515, 615, 715, 815, 915, 1015, 1115, 1215 . . . Head Section
16 . . . Rubber String
1118, 1218 . . . Pocket
150, 151 . . . Tie String
152, 153, 652, 653 . . . Wrapping Section
260, 261, 360, 361, 460, 461, 560, 561 . . . Tightening Belt
270, 271, 370, 371, 470, 471, 570, 571 . . . Belt Loop
272, 273, 372, 373, 472, 473, 572, 573 . . . Slit
661, 663 . . . Hook Piece of Hook-and-Loop Fastener
662, 664 . . . Hole Piece of Hook-and-Loop Fastener
670 . . . Waterproof Band
D . . . Stain
H . . . Person
M . . . Mattress
H1 To H4 . . . Thermally Compressed and Bonded Portion

1. An upper-half-body auxiliary bedsheet comprising:
a rectangular covering section for covering a front surface of an upper portion of a bed;
left and right folding-back sections respectively extending from left and right sides of the covering section, each of the left and right folding-back sections having a width greater than a thickness of the bed;
a head section extending from a head side of the covering section, and having a length greater than the thickness of the bed; and
left and right connecting members for respectively connecting a left end and a right end of a boundary area between the covering section and the head section, to a predetermined left position and a predetermined right position at a distal end side of the head section.

2. The upper-half-body auxiliary bedsheet according to claim 1, wherein left and right wrapping sections each having a width greater than the thickness of the bed are provided in the left and right sides of the head section.

3. (canceled)

4. The upper-half-body auxiliary bedsheet according to claim 1, wherein a waterproof bottom side portion and/or waterproof left and right side portions are provided on a front surface of the covering section.

5. An upper-half-body auxiliary bedsheet comprising:
a rectangular head section, for covering a top portion of a bed in a folded form;
a holding member, for holding the head section in the folded form;
a rectangular covering section extending from a bottom side of the head section, for covering a front surface of an upper half portion of the bed exclusive of the top portion of the bed; and
left and right folding-back sections respectively extending from left and right sides of the covering section,
wherein:
the head section, the covering section and the left and right folding-back sections are made from a single sheet member; and
the holding member allows for an adjustment of a size of an internal space of the head section in the folded form.

6. (canceled)

7. (canceled)

8. The upper-half-body auxiliary bedsheet according to claim 5, wherein
the holding member includes a plurality of connecting members that connect a left end and a right end of the sheet member folded in a vertical direction;
the connecting members include, in each of left and right sides of the head section, a belt and a belt loop in which the belt is inserted, the belt and the belt loop respectively located at two opposite positions on the side concerned; and
the belt and the belt loop are made of a single sheet member along with the head section, the covering section and the left and right folding-back sections.

9. The upper-half-body auxiliary bedsheet according to claim 8, further comprising, on both side-edge portions of the belt, a saw-tooth portion that prevents the belt inserted in the belt loop from slipping out of the belt loop.

10. (canceled)

11. The upper-half-body auxiliary bedsheet according to claim 1, wherein the covering section, the left and right folding-back sections and the head section are made of a single sheet member which has at least either a waterproof property or water-absorbing property.

12. The upper-half-body auxiliary bedsheet according to claim 1, wherein:
the left connecting member includes a pair of tie strings respectively attached to the right end of the boundary area between the covering section and the head section and the predetermined left position of the distal end side of the head section; and
the right connecting member includes a pair of tie strings respectively attached to the left end of the boundary area between the covering section and the predetermined right position of the distal end side of the head section.

13. The upper-half-body auxiliary bedsheet according to claim 1, wherein:
the left connecting member includes a pair of tie strings respectively attached to the right end of the boundary area between the covering section and the head section and the predetermined left position of the distal end side of the head section; and
the right connecting member includes a pair of tie strings respectively attached to the left end of the boundary area between the covering section and the predetermined right position of the distal end side of the head section; and
the covering section, the left and right folding-back sections, the head section, the pair of tie strings included in the left connecting member and the pair of tie strings included in the right connecting member are made of a single sheet member which has at least either a waterproof property or water-absorbing property.

14. The upper-half-body auxiliary bedsheet according to claim 1, wherein:
the left connecting member includes a rubber string stretched from the left end of the boundary area between the covering section and the head section to the predetermined left position of the distal end side of the head section; and
the right connecting member includes an elastic member stretched from the right end of the boundary area between the covering section and the head section to the predetermined right position of the distal end side of the head section.

15. The upper-half-body auxiliary bedsheet according to claim 5, wherein the head section includes a pillow-receiving portion for receiving a pillow.

16. The upper-half-body auxiliary bedsheet according to claim 11, wherein left and right wrapping sections each having a width greater than the thickness of the bed are provided in the left and right sides of the head section.

17. The upper-half-body auxiliary bedsheet according to claim 5 wherein left and right wrapping sections each having a width greater than the thickness of the bed are provided in the left and right sides of the head section.

18. The upper-half-body auxiliary bedsheet according to claim 11, wherein a waterproof bottom side portion and/or waterproof left and right side portions are provided on a front surface of the covering section.

19. The upper-half-body auxiliary bedsheet according to claim 5, wherein a waterproof bottom side portion and/or waterproof left and right side portions are provided on a front surface of the covering section.
